(19) United States
(12) Patent Application Publication
(10) Pub. No.: US 2018/0325040 A1
(43) Pub. Date: Nov. 15, 2018

(54) Plant Material Containers and Methods

(71) Applicant: Casa Flora, Inc., Dallas, TX (US)

(72) Inventor: Naud Burnett, II, Dallas, TX (US)

(21) Appl. No.: 15/591,072

(22) Filed: May 9, 2017

(51) Int. Cl. A01G 9/10; A01G 1/00; A01G 9/02

(52) U.S. Cl. CPC A01G 9/10; A01G 9/1086; A01G 9/028; A01G 1/001

(57) ABSTRACT

Systems and methods for establishing growing plant material are presented. The system is configured to grow the plant material in a non-sterile room. One method includes providing a host container comprising sidewalls and a bottom wall that forms an interior processing volume. The method further includes depositing a growth substrate into the interior processing volume and positioning an insert member into the processing volume. The insert member includes a plurality of open-bottom cells, each of the plurality of open-bottom cells includes an open bottom portion and an open top portion. The growth substrate partially extends into each of the plurality of open-bottom cells. The method also includes depositing a plant material composition over the growth substrate. Other systems and methods are presented.

### TECHNICAL FIELD

This application is directed, in general, to plant material containers and methods, and more specifically, to plant material containers and methods for establishing growing plant material.

### BACKGROUND

The process for facilitating and subsequently cultivating the beginning stages of plant growth typically take place in highly-filtered environments. The plant composition that is cultivated into plant growth is highly susceptible to being contaminated with, for example, bacteria and fungus, or other undesirable microorganisms. Thus, the need for certain process steps and, subsequently, at least partial cultivation of initial plant growth to be done in a highly-filtered environment.

A plant composition that forms the basis of plant growth is placed into a sterile or otherwise sufficiently clean container while in the highly filtered environment so as to prevent contamination of the plant composition. In some instances, a substrate is first placed into the clean container with the plant composition being placed on top of the substrate. The container holding the plant composition may then be moved to shelving units that are also contained within the filtered environment or less filtered environment or sealed to inhibit contamination. Because of the plant composition's susceptibility to contamination or infection, the container holding the plant composition must stay in a highly filtered environment until the plant composition forms sufficient plant growth that is capable of withstanding an unfiltered environment. The duration the plant composition and container must stay in the filtered environment may last several weeks. For some types of plants, the plant composition must be kept in the filtered environment for 6 to 10 weeks before the plant composition forms plant growth that is capable of withstanding an unfiltered environment. Still other plants may require much longer—some orchids may take more than a year.

The need to conduct so many processing steps for preparing the plant material for cultivation and, subsequently, cultivating the plant material into growth material within a highly filtered environment is costly. It is costly not only in the size of the filtered environment needed for processing and cultivation, but also the amount of time the plants need to remain in the filtered environment.

### SUMMARY

According to an illustrative embodiment, a method for establishing growing plant material configured to be grown in a non-sterile environment, includes providing a host container comprising sidewalls and a bottom wall. The host container forms an interior processing volume. The method further includes depositing a growth substrate into the interior processing volume of the host container. The method also includes positioning an insert member into the processing volume of the host container, which has a plurality of open-bottom cells. Each of the plurality of open-bottom cells has an open bottom portion and an open top portion. The growth substrate partially extends into each of the plurality of open-bottom cells from the open bottom portion. The method also includes depositing a plant material composition over the growth substrate. The plant material composition extends at least partially into each of the plurality of open-bottom cells. The method also includes contacting the growth substrate, and sealing the host container with a sealing material that comprises a translucent filter material that excludes particles large enough to be a bacteria or fungal spore but allows passage of gases.

According to another illustrative embodiment, a method for cultivating plant material includes pouring a growth substrate into a host container at a first temperature T₁, wherein at T₁ the growth substrate is a liquid; cooling the growth substrate to a second temperature T₂ that is less than T₁, wherein at T₂ the growth substrate is at least semi-solid; and positioning a grid member into the host container. The grid member has a plurality of cells having open bottoms and open tops. The growth substrate partially extends into each of the plurality of cells through the open bottoms. The method further includes depositing a plant material composition over the growth substrate. The plant material composition extends into the each of the plurality of cells from the open tops contacts the growth substrate. The method also includes sealing the host container with a translucent filter material that excludes particles large enough to be a bacteria or fungal spore and allows passage of gases.

According to another illustrative embodiment, a plant-material container system for receiving plant material under filtered-air conditions and being sealed to grow in an unfiltered environment includes a host container having a bottom wall, side walls, and an open top. The sidewalls are formed with a sealing-area flange. The bottom wall and sidewalls form an interior processing volume having a depth D₁. The system further includes a substrate insert member having a substrate area and having a plurality of cells over substantially all of the substrate area. Each of the plurality of cells are fluidly coupled one to another proximate a bottom portion. The substrate insert member has a depth D₂, wherein D₂<D₁. In some embodiments, the system may also include at least one clasp coupled to the host container and configured to allow the substrate insert member to be inserted into the interior processing volume and held in position. The system further includes a sealing member.

### DESCRIPTION OF THE DRAWINGS

Illustrative embodiments of the present invention are described in detail below with reference to the attached drawing figures, which are incorporated by reference herein and wherein:

FIG. 1 illustrates a perspective view of a plant material container system according to an illustrative embodiment;

FIG. 2 illustrates a perspective view of a host container, according to an embodiment, for use in the plant material container system of FIG. 1;

FIG. 3A illustrates a top view of the host container illustrated in FIG. 2;

FIG. 3B illustrates a side, elevation view of the host container illustrated in FIG. 2;

FIG. 3C illustrates an end, elevation view of the host container illustrated in FIG. 2;

FIG. 4 illustrates a cross-sectional view of the host container in FIG. 3A taken along line 4-4 and with certain substances added to processing volume;

FIG. 5A illustrates a top view of a plant material container system according to another illustrative embodiment; and

FIG. 5B illustrates a cross-sectional view of the plant material container system in FIG. 5A taken along line 5B-5B and with certain substances added to processing volume.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the claims.

Unless otherwise indicated, as used throughout this document, “or” does not require mutual exclusivity.

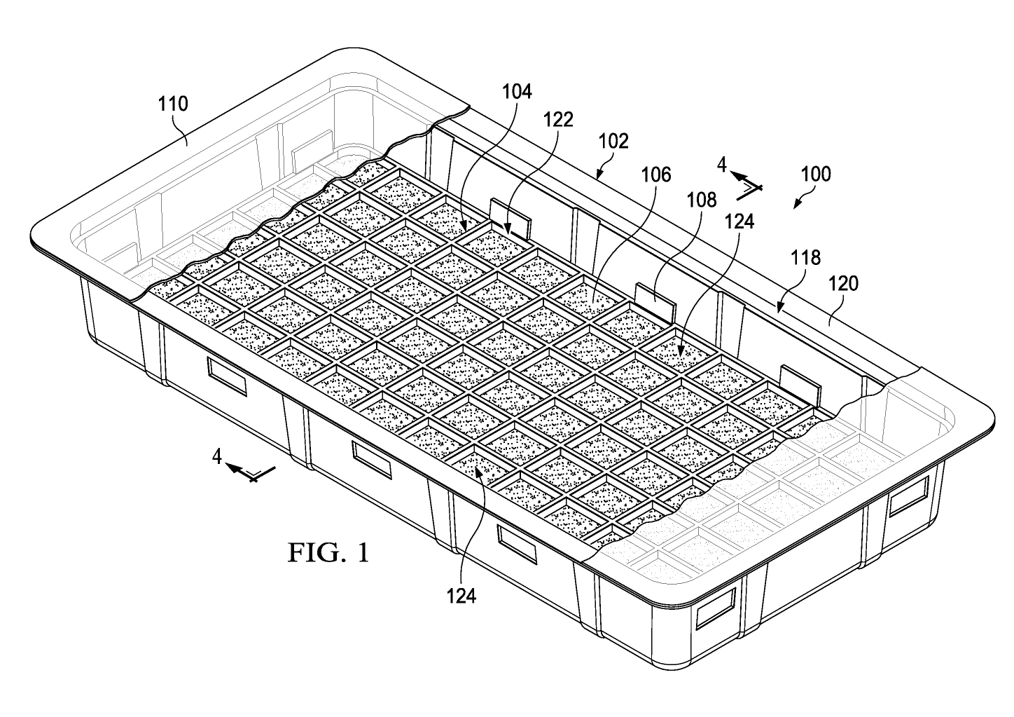

Referring primarily to FIG. 1, a plant-material container system 100 is presented. The plant-material container system 100 includes a host container 102, a substrate insert member 104 and a sealing member 110. The host container 102 is sized and configured to receive the substrate insert member 104 and be subsequently sealed using the sealing member 110. Furthermore, the host container 102 is configured to receive a plant material 106, which also may be referred to as a plant material composition. In some embodiments, the plant-material container system 100 may include one or more retaining members 108, such as a clasp, to secure the substrate insert member 104 within the host container 102. The plant-material container system 100 is configured to allow the plant material 106 to develop into plant growth in an ambient or unfiltered environment by using the sealing member 110, while protecting the plant material 106 from contamination during vulnerable stages of cultivation.

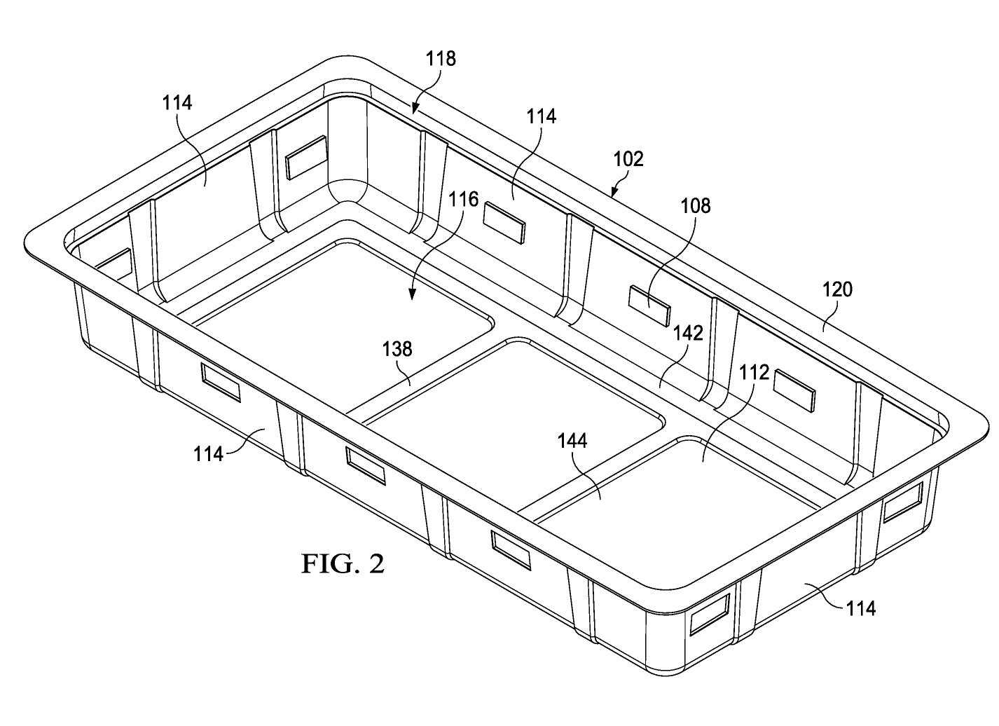

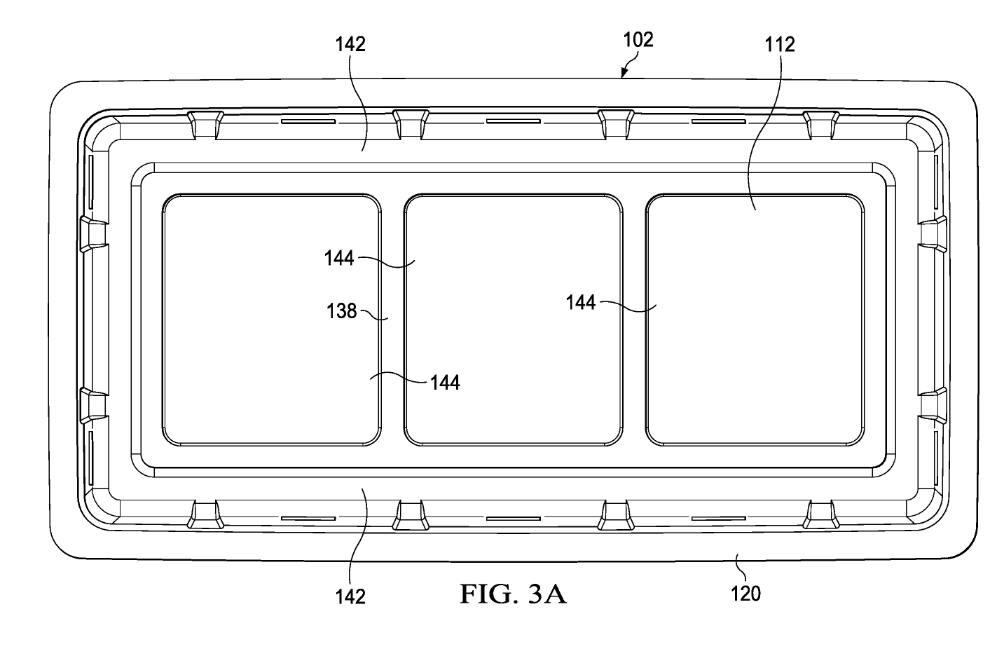

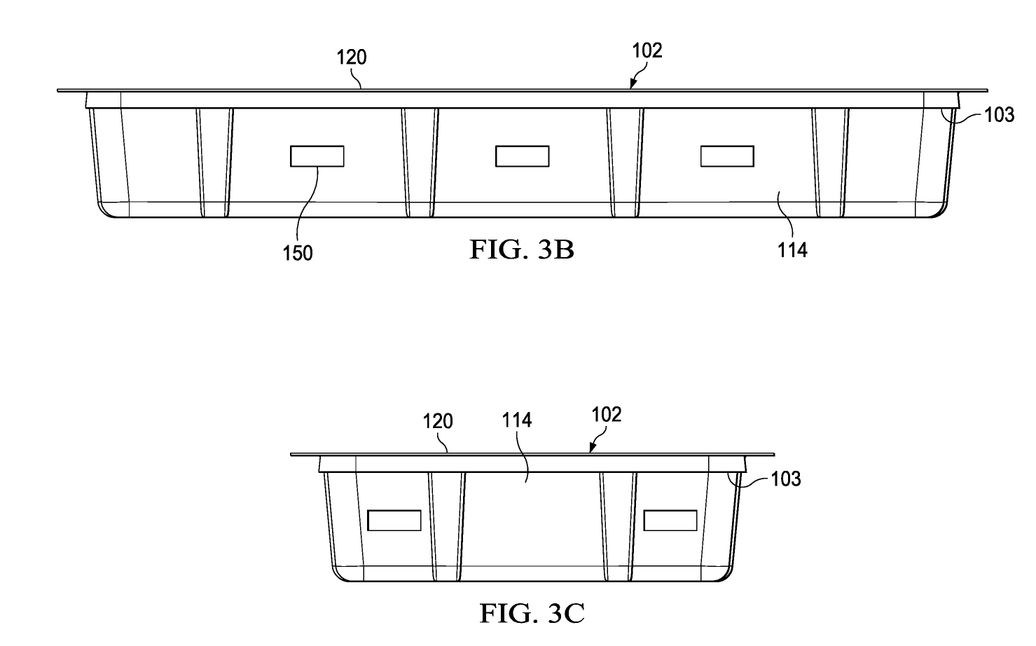

Referring now generally to FIGS. 1-4, various aspects of the plant-material container system 100 will be described in more detail. The host container 102 includes a bottom wall 112 and sidewalls 114 that form an interior processing volume 116. The sidewalls 114 may be perpendicular to opposed walls or angled outwardly or inwardly away from each other. The host container 102 has an open top 118 defined by the sidewalls 114 for allowing various materials, such as the substrate insert member 104, to be placed into the host container 102. A sealing-area flange 120 extends outwardly from a top 103 (FIG. 3B) of the sidewalls 114. In some embodiments, the sealing-area flange 120 is a perpendicular extension of the top 103 of the sidewalls 114 that extends away from an interior of the host container 102. The sealing-area flange 120 of the host container 102 is configured to receive and attach to the sealing member 110 to seal the desired contents within the processing volume 116 of the host container 102 for a certain amount of time.

In some aspects, the bottom wall 112 of the host container 102 may be uneven. Protrusions or raised portions 138 (FIG. 3A) may extend above or be formed in the bottom wall 112. Alternatively, or in addition to the raised portions 138, depressions 140 may extend below or be formed in the bottom wall 112. In some aspects, the depressions 140 may form channels 142 or wells 144. The raised portions 138 or the depressions 140 may be configured to prevent the substrate insert member 104 from sealing against the bottom wall 112 of the host container 102. In some embodiments, the raised portions 138 or the depressions 140 may facilitate liquids or viscous materials deposited into the host container 102 and adjacent the bottom wall 112 to collect in the depressions 140. In some embodiments, the raised portions 138 or the depressions 140 may be added merely to contribute to the rigidity of the host container 102. In some embodiments, the host container 102 may not have any raised portions 138 or depressions 140 and may be flat.

The host container 102 may be formed in a variety of shapes and sizes. In some aspects the host container 102 may be rectangular, square, or round. In a non-limiting, illustrative embodiment, the host container 102 may be rectangular and have a length of approximately 25 to 30 cm, a width of 10 to 18 cm, and a height of 3.5 to 4.5 cm. The host container 102 has a depth D₁ and may be formed from a translucent material that allows light to penetrate the host container 102. In some embodiments, only the bottom wall 112 and the sidewalls 114 are formed from a translucent material. In still other embodiments, the host container 102 may be opaque. In some embodiments, the host container 102 is formed as a single, integral piece. The host container 102 may be made by injection molding, vacuum forming, or other manufacturing technique.

The host container 102 is configured to receive the substrate insert member 104. In some embodiments, the retaining member 108 is coupled to the host container 102 such that the retaining member 108 holds the substrate insert member 104 within the host container 102 after the substrate insert member 104 has been positioned in the host container 102. The retaining member 108 may extend from one or more of the sidewalls 114 into the interior processing volume 116. In one embodiment, retaining members 108 are positioned on two of the sidewalls 114 that oppose each other. In yet another embodiment, the retaining members 108 are positioned on all four of the sidewalls 114. In a non-limiting, illustrative embodiment, the retaining member 108 is between approximately 1.0 and 2.5 cm above the bottommost surface of the bottom wall 112. In some embodiments, the retaining member 108 may be an integral part of the sidewalls 114 such that the retaining member 108 is formed as part of the sidewalls 114. The retaining member 108 may be at the bottom, middle, or top of the sidewalls as long as it holds the substrate insert member 104 in place.

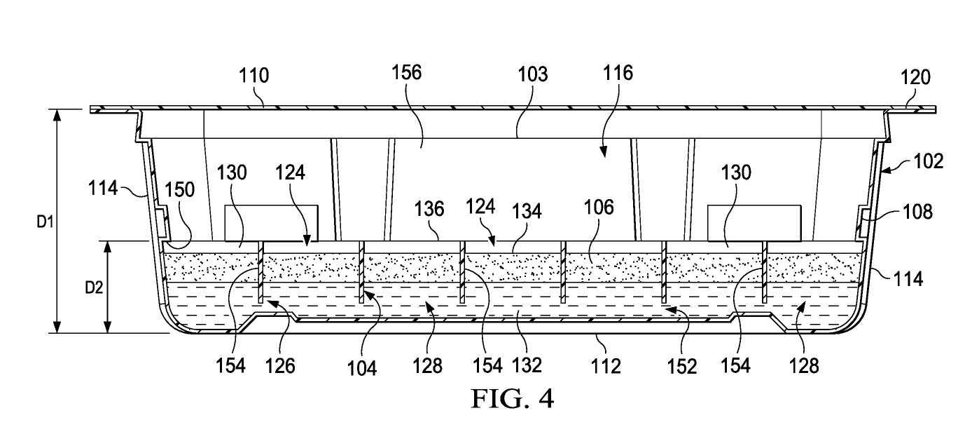

As shown best in FIGS. 1 and 4, the substrate insert member 104 includes a plurality of cells 124 and is configured to be positioned within the interior processing volume 116 of the host container 102. In some embodiments, an upper surface 136 of the substrate insert member 104 engages the retaining member 108 that protrudes from the sidewall 114 of the host container 102. The upper surface 136 of the substrate insert member 104 may be substantially flat. In some illustrative embodiments, the host container 102, the substrate insert member 104 or both are formed from at least a semi-flexible material such that when the substrate insert member 104 is inserted into the host container 102, one or both of the host container 102 or the substrate insert member 104 temporarily deforms to allow the substrate insert member 104 to slide past the retaining member 108. The upper surface 136 of the substrate insert member 104 may, in some embodiments, engage a lower surface 148 of the retaining member 108.

A bottom portion 126 of the substrate insert member 104 is positioned against or near the bottom wall 112 of the host container 102. In some embodiments, the bottom portion 126 of the substrate insert member 104 is positioned against the raised portion 138 formed in the bottom wall 112 of the host container 102, preventing the bottom portion 126 of the substrate insert member 104 from sealing against the bottom wall 112 of the host container 102. Preventing the bottom portion 126 of the substrate insert member 104 from sealing against the bottom wall 112 of the host container 102 assures at least partial fluid communication between materials placed against the bottom wall 112 of the host container 102 and materials positioned in the plurality of cells 124.

The substrate insert member 104 has a substrate area 122 (FIG. 1) that is the top planar area over the insert member 104 and the plurality of cells 124 are formed over all of or substantially all of the substrate area 122. In some embodiments, the substrate area 122 extends almost entirely between the sidewalls 114 of the host container 102. Two or more of the plurality of cells 124 may be fluidly coupled to each other via the open bottom or alternatively by features formed in the bottom portion 126 of the substrate insert member 104. For example, channels or other openings (not shown) may be formed in the bottom portion 126 that fluidly couples adjacent cells. In some illustrative embodiments, the substrate insert member 104 forms a grid that comprises the plurality of cells 124. The plurality of cells 124 may be equal in dimensions or may have a variable pattern. The shape of the plurality of cells 124 may be any suitable shape and may include square, rectangle, octagonal, hexagonal, polygonal, or round shapes. The plurality of cells 124 includes open-bottom cells that may be at least partially defined by sidewalls 154, or cell sidewalls, to create individual cells. In this embodiment, the plurality of cells 124 may include an open bottom portion 128 and an open top portion 130.

The substrate insert member 104 has a depth D₂ that is less than the depth D₁ of the host container 102. In some embodiments, the depth D₂ of the substrate insert member 104 is less than 2.5 cm. In a non-limiting, illustrative embodiment, the depth D₂ of the substrate insert member 104 is less than 1.5 cm. The substrate insert member 104 may be opaque or translucent. In one illustrative embodiment, the substrate insert member 104 is vacuum formed. It will be appreciated by one of skill in the art that there are a number of ways to form the substrate insert member 104.

The sealing member 110 is formed of a sealing material that is configured to be temporarily affixed to the sealing-area flange 120 of the host container 102. The sealing member 110 may be affixed to the sealing-area flange 120 using glue or other type of adhesive. In one embodiment, the sealing member 110 may be heat fused to the sealing-area flange 120. In other illustrative embodiments, a clasp that traps the film and flange may be used like a report binder or a thin channel. In some embodiments the sealing material is formed from at least a translucent material to allow light to penetrate through the sealing member 110. The sealing member 110 may be a translucent filter material that excludes particles large enough to be a bacteria or fungal spore but allows passage of gases. For example, the sealing member 110 allows for the permeability of CO₂. In some embodiments, the sealing member 110 is selectively permeable to allow for the exchange of some gases but not necessarily all gases. Without limitation, many bacteria and fungus spores are in the range of 0.2 microns to 20 microns. For example, most bacterial cells range in size from 0.2 to 10 microns or micrometers (0.0000079 to 0.00039 inches). Common Escherichia coli, or E. coli, bacteria are rod-shaped bacteria that typically are one micron by two microns long. As another example, aspergillus and penicillium mold spores range from 1 micron (μm) to about 8 μm. Many cladosporium and stachybotrys mold spores may be 10 μm to 20 μm (and range in shape from spherical to oblate to longer particles). These are only a few examples.

In some embodiments, the sealing member 110 may be formed of a transparent, filtering material that allows gas permeation, such as the exchange of CO₂, while blocking bacteria and other unwanted materials. In some embodiments, the plant-material container system 100 is configured such that when the sealing member 110 is in position against the host container 102, gases may only be exchanged through the sealing member 110. Additionally, the plant-material container system 100 may be configured such that when the sealing member 110 is sealed against the host container 102, liquids or other materials may not be inserted or removed from the host container 102. In some illustrative embodiments, the sealing member 110 is a transparent film that has one or more embedded filters or filter members that allow gases to be exchanged therethrough but inhibit passage of particles large enough to be bacteria, fungus or other contaminating particles.

Referring now primarily to FIG. 4, but with continued reference to FIGS. 1-3C, a cross-sectional view of the plant-material container system 100 is shown with the plant material composition 106 and a growth substrate 132 deposited there in. In some embodiments the growth substrate 132 may include growth media, such as sugar, vitamins, hormones, salts, etc., for the plant material composition 106 to feed from during the growth process. The growth substrate 132 may be a liquid at a first temperature T₁ and at least semisolid at a second temperature T₂, where T₁>T₂. In one illustrative, non-limiting embodiment, the growth substrate 132 is a liquid when the first temperature T₁ is approximately 80° C. and at least semisolid when the second temperature T₂ is approximately 60° C. The growth substrate 132 will have a temperature variance between a liquid state and a semisolid state that maintains the viability of the growth media. The gelling temperatures are highly dependent on dilution rates, chemical composition of substrate and type, concentration and combination of gelling agents. In one non-limiting illustrative embodiment, the growth substrates 132 turns into a semi-solid (T₂) at about 40° C. and so T₂ should be below 40° C. Other temperatures may be used to provide the same effect depending on conditions.

As will be explained in more detail below, the growth substrate 132 may be deposited into the host container 102 as a liquid and then allowed to cool into a semisolid state. In an illustrative embodiment, the growth substrate 132 has a substantially flat upper surface when cooled into it semisolid state. The plant material composition 106 may include blended or shredded portions of a plant that is suspended in a solution or any suspended plant structure capable of growing seeds, spores, etc. The plant material composition 106 is deposited over the growth substrate 132. In some embodiments, the insert member may be inserted into the host container 102 while the growth substrate 132 is a liquid.

As can be seen in FIG. 4, in one illustrative embodiment, the substrate insert member 104 is positioned in the host container 102 with the upper surface or portion 136 of the substrate insert member 104 secured by the bottom surface 150 of the retaining member 108. Gaps 152 are formed between the bottom portion 126 of the substrate insert member 104 and the bottom wall 112 of the host container 102, allowing for fluid communication between at least two or more of the plurality of cells 124. Fluid communication also allows for resource sharing as the plant material 106 grows. This is different than closed, isolated cells.

The growth substrate 132 is positioned against the bottom or bottom wall 112 of the host container 102 and extends at least partially into the plurality of cells 124 of the substrate insert member 104. The growth substrate 132 is positioned in the gaps 152, allowing the growth substrate 132 to be in fluid communication between the plurality of cells 124. The plant material composition 106 is positioned over the growth substrate 132—deposited from the top for the orientation shown. In some embodiments an uppermost or upper surface 134 of the plant material composition 106 is below the upper or uppermost surface 136 of the substrate insert member 104. In some illustrative embodiments, the plant material composition 106 can be below, level with, or above the upper surface 136 depending on the level of the growth substrate 132, thickness of plant material composition 106, or method of deposition of plant material composition 106. The plant material composition 106 may be positioned in each of the plurality of cells 124 such that the sidewalls 154 of the plurality of cells 124 extend above the uppermost surface 134 of the plant material composition 106. Allowing the sidewalls 154 for the plurality of cells 124 to extend above the plant material composition 106 may allow the sidewalls 154 to provide support for plant growth that is cultivated from the plant material composition 106 or prevent plant parts from intertwining or growing together between the cells of the plurality of cells 124 (in growing media as well as in the container). The plant growth may include roots, leaves or stems.

As previously mentioned, the plant growth material 106 is susceptible to contamination from sources that include bacteria, fungus, or other unwanted microorganisms. Thus, the initial process steps for preparing the plant growth material 106 for cultivation into plant growth occurs in a filtered environment. As used herein, “filtered environments” includes an environment that is sufficiently clean of unwanted contaminants so as not to impede healthy growth of plant material and that prevents contaminants from entering the filtered environment. Ultimately, however, the plant-material container system 100 is configured to cultivate the plant growth material 106 in an ambient, non-filtered, nonsterile type environment once the plant material 106 has been sealed within the host container 102 by the sealing member 110.

In operation, the interior of the host container 102 should be sterile or otherwise sufficiently clean of bacteria or other contaminating material. The host container 102 is placed in a filtered environment. Likewise, the substrate insert member 104 is sterile or sufficiently clean of bacteria or other contaminants and is also placed in the filtered environment.

While in the filtered environment, the growth substrate 132 is deposited into the interior processing volume 116 of the host container 102. In some embodiments, the growth substrate 132 may be disposed into the interior processing volume 116 to a depth of 10% D₁ to 90% D₁. The substrate insert member 104 may be positioned into the interior processing volume 116 either before or after the growth substrate 132 is deposited into the interior processing volume 116. In some embodiments, the growth substrate 132 is poured into the host container 102 at the first temperature T₁, at which the growth substrate 132 is a liquid. In some embodiments, the first temperature T₁ may be approximately 80° C. The growth substrate 132 may be poured into the host container 102 in a liquid state either before or after the substrate insert member 104 is positioned in the host container 102. Regardless of whether the growth substrate 132 is poured into the host container 102 before or after the substrate insert member 104 is positioned in the host container 102, the growth substrate 132 is positioned across the plurality of cells 124 at a substantially even level and with fluid communication between the bottoms of each of the plurality of cells 124. In an illustrative embodiment, a predetermined volume or amount of the growth substrate 132 is deposited into the host container 102 and into the processing volume 122 such that the growth substrate 132 will reach a desired position or height against the sidewalls 154 of the plurality of cells 124.

In some embodiments, the growth substrate 132 is allowed to harden into a semisolid state prior to depositing the plant material 106 over the growth substrate 132. The process of hardening the growth substrate 132 may include allowing the growth substrate 132 to cool to the second temperature T₂. In some embodiments, the second temperature T₂ may be approximately 60° C. or in other embodiments may be 40° C. or below. Allowing the growth substrate 132 to harden into a semisolid state prior to depositing the plant material 106, may help prevent portions of the growth substrate 132 from being moved between the plurality of cells 124 during the plant material 106 depositing process.

In one illustrative, non-limiting embodiment, a temporary seal (not explicitly shown but analogous to sealing member 110) is positioned on the host container 102 after the growth substrate 132 has been poured into the host container 102 but before the plant material 106 has been added. In this embodiment, the host container 102 may then be removed from the filtered environment and placed in a nonfiltered environment. This step may allow the growth substrate 132 to harden in an unfiltered or ambient environment while maintaining a clean environment within the host container 102. Likewise, this step may allow the host container 102 with the growth substrate 132, which optionally includes the substrate insert member 104, to be stored in a nonfiltered environment until the step of positioning the plant growth material 106 into the host container 102 is to be performed. If this step is implemented, the host container 102 may subsequently be reinserted into a filtered environment prior to the temporary seal being removed and the substrate insert member 104 introduced. In other embodiments, the growth substrate 132 is introduced and then after sufficient time, the plant material composition is added.

Once the substrate insert member 104 and the growth substrate 132 have been placed in the processing volume 116 of the host container 102, the plant material 106 may be deposited into the host container 102. The plant material 106 extends into each of the plurality of cells 124 via the open top portion 130 and contacts the growth substrate 132. The plant material 106 may be deposited by pouring or spreading with wiper (or squeege) the plant material 106 over the growth substrate 132. In an illustrative embodiment, a predetermined volume or amount of the plant material 106 is deposited, e.g., poured, sprayed, spread, etc., into the processing volume 116 of the host container 102. In some embodiments, the amount of the plant material 106 is determined such that the plant material 106 only extends partway up the sidewalls 154 of the plurality of cells 124. In other words, a predetermined amount of the plant material 106 is deposited such that when the plant material 106 is distributed into the plurality of cells 124, the uppermost surface 134 of the plant material 106 is below the upper surface 136 of the substrate insert member 104. The plant material 106 does not have to be, but can be, below the top 136 of the insert member 104. The plant material 106 may be level with or even above the upper surface of the insert member 104 depending on how the plant material 106 is delivered to each cell. If the plant material 106 is wiped (squeegeed) on to the surface, the plant material 106 can be below or level with the top of the insert. If the plant material 106 is squirted or deposited in each cell, the plant material 106 could be above the level of the insert member 104 depending on surface tension and viscosity of the plant material 106.

While still in the filtered environment, the sealing member 110 is affixed to the host container 102 on the sealing-area flange 120. The sealing member 110 may be formed from a translucent, filtering material that allows permeability of CO₂, while preventing unwanted contaminants from entering a sealed space 156 and contaminating the plant material 106. Again, the sealing material 110 may be a translucent filter material that excludes particles large enough to be a bacteria or fungal spore but allows passage of gases. The sealing member 110 may be transparent. Once the host container 102 has been sealed with the sealing member 110, the sealed host container 102 may be transferred to an ambient, nonfiltered or otherwise nonsterile environment that provides the proper conditions to cultivate the plant material 106 into plant growth. Depending on the type of plant being grown, as well as other factors, the plant material 106 may need to be sealed within the host container 102 for several weeks. In some instances, the plant material 106 may need to be sealed within the host container 102 for 6 to 10 weeks or as long as need for different plants—certain orchids can take over a year. Once sufficient plant growth has occurred, the sealing member 110 may be removed from the host container 102 while the host container 102 is in the unfiltered environment. The plant growth may then be transferred from its cell to another container or pot that contains potting compost. The retaining member 108 may help prevent the substate insert member 104 from lifting out of the host container 102 during the transfer process. The plant growth then continues its growth in an ambient or unfiltered environment.

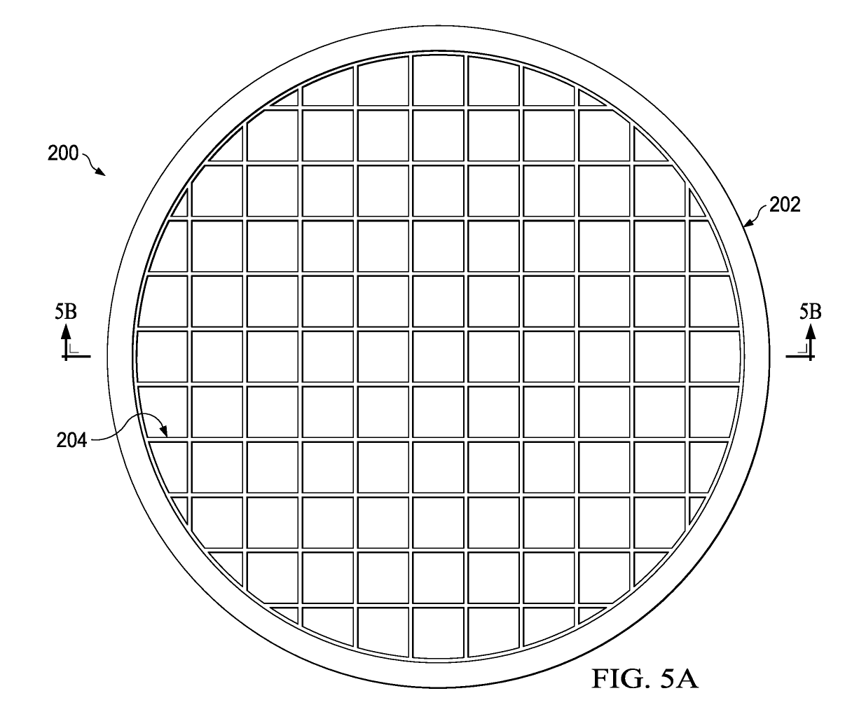

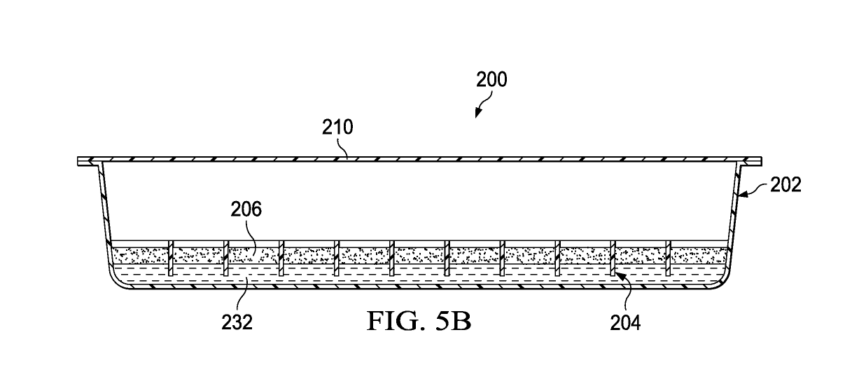

Referring now to FIGS. 5A-5B, another embodiment of the plant-material container system 200 is presented. The plant-material container system 200 is similar to the plant-material container system 100 illustrated in FIGS. 1-4 in that the plant-material container system 200 is configured to hold a growth substrate 232 and a plant material composition 206. The plant-material container system 200 may include a host container 202, a substrate insert member 204 and a sealing member 210. In contrast to the plant-material container system 100, the host container 202 of the plant-material container system 200 has a rounded shape as seen in plan view and the substrate insert member 204 also has a rounded shape that mimics the shape of the host container 202. Again, other shapes are also possible. The container sidewalls in FIG. 5B are angled outwardly from each, but it should be understood that the container sidewalls may also be angled inwardly or be parallel relative to each other in other illustrative embodiments.

According to an illustrative, non-limiting embodiment, a method for cultivating plant material comprises (1) pouring a growth substrate into a host container at a first temperature T₁, wherein at T₁ the growth substrate is a liquid; (2) positioning a grid member into the host container. The grid member has a plurality of cells having open bottoms and open tops. The growth substrate is positioned to partially extend into each of the plurality of cells through the open bottoms. The method further includes (3) cooling the growth substrate to a second temperature T₂ that is less than T₁, wherein at T₂ the growth substrate is at least semi-solid; (4) depositing a plant material composition over the growth substrate. The plant material composition extends into the each of the plurality of cells from the open tops and contacts the growth substrate. The method further includes (4) sealing the host container with a sealing material that comprises a translucent filter material that excludes particles large enough to be a bacteria or fungal spore while allowing passage of gases. The method may further include removing the sealing material and planting the resultant plant growth material.

Although the present invention and its advantages have been disclosed in the context of certain illustrative, non-limiting embodiments, it should be understood that various changes, substitutions, permutations, and alterations can be made without departing from the scope of the invention as defined by the claims. It will be appreciated that any feature that is described in a connection to any one embodiment may also be applicable to any other embodiment.

What is claimed:

1. A method for establishing growing plant material configured to be grown in a non-sterile room, the method comprising:
providing a host container comprising sidewalls and a bottom wall, the host container forming an interior processing volume;
depositing a growth substrate into the interior processing volume of the host container;
positioning an insert member into the processing volume of the host container, the insert member having a plurality of open-bottom cells, each of the plurality of open-bottom cells having an open bottom portion and an open top portion;
wherein the growth substrate partially extends into each of the plurality of open-bottom cells from the open bottom portion;
depositing a plant material composition over the growth substrate, the plant material composition extending at least partially into the each of the plurality of open-bottom cells and contacting the growth substrate; and
sealing the host container with a sealing material that comprises a translucent filter material that excludes particles large enough to be a bacteria or fungal spore while allowing passage of gases.

2. The method of claim 1, further comprising the step of hardening the growth substrate prior to depositing the plant material composition.

3. The method of claim 1, wherein the insert member comprises a grid that forms the plurality of open-bottom cells.

4. The method of claim 1, wherein the sealing material comprises a transparent film that includes at least one embedded filter member.

5. The method of claim 1, wherein the growth substrate is in a liquid state when deposited, the method further comprising the step of hardening the growth substrate into at least a semi-solid state.

6. The method of claim 5, further comprising:
sealing the host container at top portion with a temporary seal during the step of hardening the growth substrate into the at least the semi-solid state; and
removing the temporary seal prior to the step of depositing the plant material composition.

7. The method of claim 1, wherein during the step of depositing the growth substrate, the growth substrate is a first temperature T₁, and wherein during the step of depositing the plant material composition the growth material is a second temperature T₂, wherein T₂ is less than T₁.

8. The method of claim 1, wherein the step of depositing the growth substrate into the host container occurs before the step of positioning the insert member into the host container.

9. The method of claim 1, further comprising the step of securing the insert member to the host container.

10. A method for cultivating plant material, the method comprising:
pouring a growth substrate into a host container at a first temperature T₁, wherein at T₁ the growth substrate is a liquid;
positioning a grid member into the host container, the grid member having a plurality of cells having open bottoms and open tops, wherein the growth substrate partially extends into each of the plurality of cells through the open bottoms;
cooling the growth substrate to a second temperature T₂ that is less than T₁, wherein at T₂ the growth substrate is at least semi-solid;
depositing a plant material composition over the growth substrate, the plant material composition extending into the each of the plurality of cells from the open tops and contacting the growth substrate; and
sealing the host container with a sealing material that comprises a translucent filter material that excludes particles large enough to be a bacteria or fungal spore while allowing passage of gases.

11. The method of claim 10, wherein the steps of pouring, cooling, positioning, depositing and sealing are performed in a filtered environment.

12. The method of claim 11, wherein after the step of sealing the host container with the transparent, filtering material, the method further comprises the step of removing the host container from the filtered environment and placing the host container, sealed with the transparent, filtering material, in an ambient environment.

13. The method of claim 10, further comprising:
sealing the host container with a seal after the step of pouring the growth substrate into the host container;
transferring the host container sealed with the seal from a filtered environment to an ambient environment;
after the step of cooling the growth substrate to the T₂, transferring the host container sealed with the seal back to the filtered environment; and
removing the seal from the host container.

14. The method of claim 10, wherein the step of positioning the grid member into the host container occurs after the step of pouring the growth substrate into the host container and before the step of cooling the growth substrate to T₂.

15. The method of claim 10, wherein the growth substrate comprises a first growth substrate positioned in a first cell of the plurality of cells and a second growth substrate positioned in a second cell of the plurality of cells, wherein the first growth substrate is fluidly coupled with the second growth substrate.

16. The method of claim 10, wherein the step of depositing the plant material composition includes pouring or spreading the plant material composition over the growth substrate.

17. The method of claim 10, wherein a predetermined volume of the plant material composition is deposited such that an uppermost surface of the plant material composition is below an uppermost surface of the grid member.

18. A plant-material container system for receiving plant material under filtered-air conditions and being sealed to grow in an unfiltered environment, the plant-material container system comprising:
a host container having a bottom wall coupled to side walls and having an open top, wherein the side walls are formed with a sealing-area flange on an upper portion, wherein the bottom wall and side walls form an interior processing volume having a depth D₁;
a substrate insert member having a substrate area and having a plurality of cells formed over substantially all of the substrate area, wherein each of the plurality of cells are fluidly coupled one to another proximate a bottom portion, the substrate insert member having a depth D₂, wherein D₂<D₁ so that the substrate insert member fits within the host container; and
a sealing material for releasably coupling to the sealing-area flange, the sealing material comprising a translucent filter material that excludes particles large enough to be a bacteria or fungal spore while allowing passage of gases.

19. The plant-material container system of claim 18, further comprising at least one clasp coupled to the host container and configured to allow the substrate insert member to be inserted into the interior processing volume and held in position.

20. The plant-material container system of claim 18, further comprising:
wherein the plurality of cells of the substrate insert member comprise a plurality of open-bottom cells that are each open on a bottom and on a top;
a growth substrate disposed into the interior processing volume of the host container to a depth of approximately 10% D₁ to 90% D₁; and
a plant material composition disposed at least partially into each of the plurality of open-bottom cells.
